(19) United States
(12) Patent Application Publication
(10) Pub. No.: US 2025/0272085 A1
(43) Pub. Date: Aug. 28, 2025

(54) SYSTEM AND METHOD FOR CODE AND DEVIATION MANAGEMENT

(71) Applicant: TOYOTA JIDOSHA KABUSHIKI KAISHA, Toyota-shi (JP)

(72) Inventor: Daisuke HASHIMOTO, Tokyo (JP)

(73) Assignee: TOYOTA JIDOSHA KABUSHIKI KAISHA, Toyota-shi (JP)

(21) Appl. No.: 18/590,196

(22) Filed: Feb. 28, 2024

(51) Int. Cl. G06F 8/70

(52) U.S. Cl. CPC G06F 8/70

(57) ABSTRACT

Provided are embodiments for code and deviation management. A method implementing a large language model (LLM) may be provided. The method may include: receiving, from a user, a source code; determining whether or not the source code violates at least one coding rule; based on determining that the source code violates the at least one coding rule, presenting information associated with the violation to the user; receiving, from the user, a user feedback associated with the presented information; determining, based on the user feedback, whether or not at least one rule deviation is to be implemented; based on determining that the at least one rule deviation is to be implemented, performing at least one operation to manage at least one deviation report; and based on determining that the at least one rule deviation is not to be implemented, performing at least one operation to manage the source code.

### TECHNICAL FIELD

Example embodiments of the present disclosure relate to code and deviation management, and more particularly, relate to code analysis and coding rule deviation management.

### BACKGROUND

In the processes of software development, adherence and compliance with coding rules are crucial for ensuring code quality, security, maintainability, and overall system integrity. It is important to ensure that the source code complies with the associated coding rules (e.g., standard coding rules, internal coding rules, etc.) and to prevent the source code from deviating from the associated coding rules. When a deviation from a coding rule(s) is unavoidable, the deviation is required to be handled and managed carefully.

In the related art, a user (e.g., a software engineer, etc.) is required to manually run analysis on the source code via Continuous Integration/Continuous Delivery (CI/CD) procedures, in which the user needs to carefully check the source code with a large list of coding rules, thereby determining whether or not the source code violates any of the coding rules. Upon determining that the source code violates a coding rule(s), the user needs to manually determine a code modification that may avoid the coding rule violation(s). In this regard, the user needs to manually research potential solutions.

Further, upon determining that the coding rule violation(s) is unavoidable, the user needs to manually check if there is any rule deviation(s) in the past that resolved a similar issue, or manually check if any existing rule deviation(s) can be modified to address the coding rule violation(s). Subsequently, based on determining that there is no available rule deviation(s), the user needs to manually apply for a new rule deviation. Accordingly, a second user (e.g., a member of the coding rule committee, etc.) needs to review the application of the new rule deviation, manually assign a deviation ID to the specific case, and then provide the result of the review (e.g., application approved, application rejected, etc.) to the first user (e.g., the software engineer that applied for the new rule deviation).

In view of the above, in the related art, a significant amount of time and effort is required from the associated users in the procedures of manual code reviews, manual code modification analysis (when the code violates a coding rule), and manual deviation management (e.g., review of available rule deviations, modify existing rule deviation, apply for new rule deviation, etc.). These manual procedures are prone to oversight and human error. Particularly, whenever a source code violates multiple coding rules, the solution for addressing such a violation may be complex and the users may not easily or effectively find the viable solution for addressing the violation.

Further, the user may not be able to effectively or accurately determine whether or not a rule deviation should be implemented. For instance, the user may not aware of a potential code modification (for addressing the violation) can avoid the rule deviation, may not aware that an existing deviation report can be modified which can avoid creating a new deviation report, may not aware that a same deviation report has been created in the past and create the same deviation report again, and the like. Accordingly, redundant resources will be wasted and the code and deviation management may be complicated.

Furthermore, related art systems and methods lack the capability to intelligently or automatically handle code and coding rule deviation management, resulting in inefficiencies and delays in the software development process. Further, related art systems and methods often fail to provide comprehensive solutions when the users encounter coding rule violations, leading to time-consuming manual interventions and potential errors in code modification.

Due to at least the aforementioned issues, there is a need for an automated solution that can intelligently identify coding rule violations, present viable code modifications, and review and suggest appropriate deviation-related operations.

### SUMMARY

Example embodiments consistent with the present disclosure provide methods, systems, and apparatuses for effectively and efficiently managing a code and a coding rule deviation associated therewith.

According to embodiments, a method, performed by at least one processor of a system upon executing instructions for implementing a large language model (LLM), is provided. The method may include: receiving, from a first user, a source code; determining whether or not the source code violates at least one coding rule; based on determining that the source code violates the at least one coding rule, presenting information associated with the violation of the at least one coding rule to the first user; receiving, from the first user, a first user feedback associated with the presented information; determining, based on the first user feedback, whether or not at least one rule deviation is to be implemented; based on determining that the at least one rule deviation is to be implemented, performing at least one operation to manage at least one deviation report according to the first user feedback; and based on determining that the at least one rule deviation is not to be implemented, performing at least one operation to manage the source code.

According to embodiments, a system for code and deviation management is provided. The system may include a memory storage storing computer-executable instructions for implementing a large language model (LLM) and at least one processor communicatively coupled to the memory storage. The at least one processor may be configured to execute the instructions to: receive, from a first user, a source code; determine whether or not the source code violates at least one coding rule; based on determining that the source code violates the at least one coding rule, present information associated with the violation of the at least one coding rule to the first user; receive, from the first user, a first user feedback associated with the presented information; determine, based on the first user feedback, whether or not at least one rule deviation is to be implemented; based on determining that the at least one rule deviation is to implemented, perform at least one operation to manage at least one deviation report according to the first user feedback; and based on determining that the at least one rule deviation is not to be implemented, perform at least one operation to manage the source code.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture, according to one or more embodiments;

FIG. 2 illustrates example components of a code and deviation management system, according to one or more embodiments;

FIG. 3 illustrates a flow diagram of an example method for reviewing a source code and performing one or more operations based thereon, according to one or more embodiments;

FIG. 4 illustrates a flow diagram of an example method for determining whether or not at least one rule deviation is to be implemented, according to one or more embodiments;

FIG. 5 illustrates a flow diagram of an example method for determining at least one operation for responding to a coding rule violation, according to one or more embodiments;

FIG. 6 illustrates an example deviation report, according to one or more embodiments; and

FIG. 7 to FIG. 9B illustrates diagrams of several example graphical user interfaces (GUIs), according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, although example embodiments of the present disclosure are described in relation to a “source code”, it is contemplated that the present disclosure may be similarly applicable to any suitable types of software programming code (e.g., machine code, object code, bytecode, script code, markup code, configuration code, database code, etc.), without departing from the scope of the present disclosure.

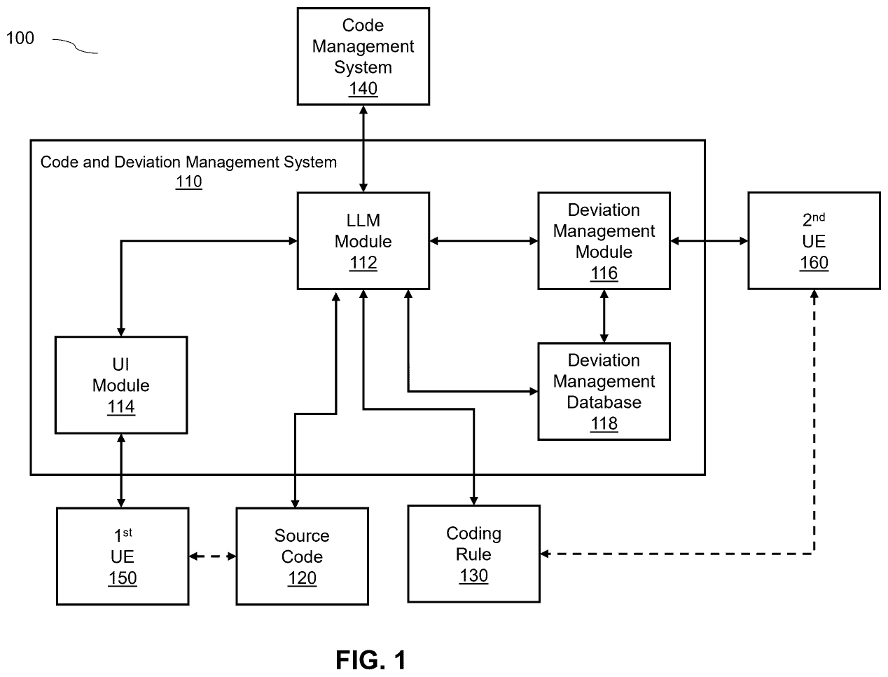

FIG. 1 illustrates a block diagram of an example system architecture 100, according to one or more embodiments. As illustrated in FIG. 1, a code and deviation management system 110 (“the system 110” hereinafter) may include a large language model (LLM) module 112 (“the module 112” hereinafter), a user interface (UI) module 114 (“the module 114” hereinafter), a deviation management module 116 (“the module 116” hereinafter), and a deviation management database 118 (“the database 118” hereinafter).

According to embodiments, one or more of the components of the system 110 (i.e., components 112-118) may be implemented in different forms of hardware, firmware, or a combination of hardware and software. In this regard, it is contemplated that one or more operations described herein with reference to each of the components 112-118 may be performed by a hardware (e.g., a processor, etc.) upon executing a software or computer-executable instructions for implementing the components 112-118.

Further, although it is illustrated in FIG. 1 that the components 112-118 are included in the system 110, it is contemplated that one or more of the components may be excluded from the system 110, without departing from the scope of the present disclosure. For instance, the module 112 and module 114 may be implemented in a first server, while the module 116 and/or the database 118 may be implemented in a second server different from the first server, and the like.

The LLM module 112 may be configured to interoperate with the module 114, the module 116, and the database 118 to perform one or more operations for reviewing or analyzing a programming code, identifying one or more deviations from one or more coding rules, and assisting one or more users in managing and addressing the one or more deviations. In another embodiment, the LLM module 112 may be configured to interoperate with a module implemented with rule-based code (instead of or in addition to AI/ML model) for analyzing the programming code. According to embodiments, the implementation of the LLM module 112 enables automated processes for handling coding rule deviation incidents. For instance, the LLM module 112 may suggest or implement automated code modification, deviation report creation, and/or deviation report modification, thereby enabling the associated user(s) to address the coding rule deviation(s) efficiently and consistently.

According to embodiments, the LLM module 112 (or a component configured to implement the module 112) may receive at least one programming code (e.g., source code 120, etc.) and at least one coding rule (e.g., coding rule 130), and then perform one or more natural language processing (NLP) operations to process the code and manage coding rule deviation based thereon (if any).

The one or more NLP operations may include, for example, code analysis, coding rule violation detection, context-aware interaction with a user, and deviation management. The code analysis may include one or more of: identifying code changes, interpreting code's structure, semantics, and/or objective, extracting or summarizing the context of the code, and comprehending the relationships between the code elements (e.g., syntax, comments, descriptions, etc.) The coding rule violation detection may include one or more of: identifying instances of coding rule violations within the analyzed code, categorizing violations, and assessing the severity of the violations. The interactions with the user may include one or more of: providing code analysis information, analyzing user feedback, providing recommendations for code modification, providing recommendations for deviation report modification, providing recommendations for deviation report creation, and requesting supplemental information from the user. The deviation management may include one or more of: creating and applying a new deviation report, modifying an existing deviation report, interacting with the associated user(s) for notifying and requesting approval about the application for the new deviation report and/or modification of the existing deviation report, and the like.

According to embodiments, the LLM module 112 may execute or utilize one or more artificial intelligence (AI)/machine learning (ML) models to perform one or more operations described herein. The one or more AI/M1 models may include: one or more transformer models, one or more recurrent neural network (RNN) models, one or more embeddings from language models (ELMo), and/or any other suitable type of models trained based on any other suitable learning architectures.

According to embodiments, the LLM module 112 may be configured to receive a source code 120 and a coding rule 130 from one or more sources external to the system 110. For instance, the LLM module 112 may receive the source code 120 from a first user equipment (UE) 150, may receive the coding rule 130 from a second UE 160, or may receive the source code 120 and/or the coding rule 130 from any other suitable source(s). Further, the LLM module 112 may receive the source code 120 and/or the coding rule 130 via the UI module 114 (or one or more interfaces generated and presented by the UI module 114).

According to embodiments, the coding rule 130 may be pre-stored in a repository and be retrieved by the LLM module 112 when required. For example, upon receiving the source code 120, the LLM module 112 may determine which coding rule(s) is associated with the source code 120 and then obtain the associated coding rule(s) thereafter.

The source code 120 may include a new source code, a modified source code (e.g., updated code, revised code, etc.), or the differences (diff) between different versions of the source code. Further, the source code 120 may be defined or written in Java, Python, C, C++, JavaScript, PHP, Ruby, Swift, Go, Rust, or any suitable programming language.

The coding rule 130 may include one or more sets of coding rules that the source code 120 is expected to comply with. The coding rule may include various aspects of coding requirements, such as code indentation, naming conventions, variable usage, code complexity, security requirements, and the like. According to embodiments, the coding rule 130 may include one or more standard coding rules, such as: coding rule(s) from the Motor Industry Software Reliability Association (MISRA), coding rule(s) from AUTomotive Open System ARchitecture (AUTOSAR), coding rule(s) from Computer Emergency Response Team (CERT), and the like. Additionally or alternatively, the coding rule 130 may include one or more internal rules configured or managed by a dedicated user and/or a dedicated team (e.g., a rule committee, etc.) that manage or operate the system 110.

According to embodiments, the source code 120 may be provided by a first user via the first UE 150, the coding rule 130 may be provided by a second user via the second UE 160, or the like. Alternatively, the source code 120 and/or the coding rule 130 may be provided by one or more components different from the first UE 150 and/or the second UE 160. For instance, the source code 120 may be stored in a code management system 140 (“the system 140” hereinafter), and may be retrieved by the LLM module 112 when required. Similarly, the coding rule 130 may be pre-stored in a repository or a server, and may be obtained by the system 110 when required.

Upon receiving the source code 120 and the coding rule 130, the LLM module 112 may be configured to review or analyze the source code 120 to determine whether or not the source code 120 violates the coding rule 130. For instance, the LLM module 112 may scan the source code 120 to determine whether or not the source code 120 includes any issues such as inconsistent formatting, the use of prohibited constructs, the appearance of typographical errors, insufficient security features, and/or other violations of the coding rule 130.

According to embodiments, based on determining that the source code 120 violates the coding rule 130, the LLM module 112 may interoperate with the user interface (UI) module 114 to communicate and interact with the first user associated with the first UE 150, and then manage the source code 120 based on one or more feedbacks provided by the first user via the first UE 150. For instance, the module 112 may determine instance(s) where the source code 120 violates the coding rule 130, and may provide the information to the module 114. Accordingly, the module 114 may generate one or more UIs including the information provided by the module 112, and then present the one or more UIs to the first UE 150 thereby notifying the first user regarding the information associated with the violation (may be referred to as “violation information” herein).

According to embodiments, the module 112 may receive the one or more user feedbacks from the first UE 150 via the one or more UIs presented by the UI module 114. Subsequently, the module 112 may determine, based on the one or more user feedbacks, whether or not at least one rule deviation is to be implemented.

Based on determining that the at least one rule deviation is to be implemented, the module 112 may summarize the one or more user feedbacks and interoperate with the module 116 and the database 118 to manage one or more deviation reports based on the summary of the user feedback. For instance, the module 112 may create one or more new deviation reports, may instruct the module 116 to create the one or more new deviation reports, may retrieve one or more existing deviation reports from the database 118 and modify the one or more existing deviation reports, may instruct the module 116 to modify one or more existing deviation reports, may instruct the module 116 to interact or communicate with the second user, and the like.

On the other hand, based on determining that the at least one rule deviation is not to be implemented, the module 112 may perform one or more operations to manage the source code 120. For instance, the module 112 may modify the source code 120 based on at least one code modification presented to and agreed by the first user, thereby avoiding the violation of coding rule 130. Subsequently, the module 112 may output or provide the modified source code 120 to the code management system 140. For instance, the module 112 may generate and send a Pull Request command, a Merge Request command, a Push command, and/or any other suitable request or message, to the system 140, such that the system 140 may appropriately receive and store the modified source code 120. Upon successful storage or upload of the modified source code 120, the module 112 may provide a notification or a trigger to the module 114, and the module 114 may generate and present a notification message to the first UE 150 to notify the first user regarding the successful upload of the modified source code 120. Alternatively, the module 112 may return the source code 120 to the first user for revision or reconsideration, without modifying the source code 120.

According to embodiments, based on determining that the source code 120 does not violate the coding rule 130, the module 112 may output or provide the reviewed source code 120 to the code management system 140. For instance, the module 112 may generate and send a Merge command and/or a Push command (or any other suitable request or message) to the system 140, such that the system 140 may appropriately receive and store the reviewed source code 120. Upon successful storage or upload of the reviewed source code 120, the module 112 may provide a notification or a trigger to the module 114, and the module 114 may generate and present a notification message to the first UE 150 to notify the first user regarding the successful review and/or successful upload of the reviewed source code 120.

The UI module 114 (or a component configured to implement the module 114) may be configured to facilitate communication or interaction with one or more users. For instance, the module 114 may enable the first user to interact with the system 110 via the first UE 150. Specifically, the module 114 may receive information or data from the module 112, and then generate and present one or more user interfaces to engage the first user. In addition, the module 114 may receive one or more user feedbacks from the first user via the presented user interface(s), and then provide the one or more user feedbacks to the module 112.

According to embodiments, the one or more user interfaces generated by the module 114 may include one or more graphical user interfaces (GUIs). The one or more GUIs may include one or more chat windows (and/or other interactive interfaces) and one or more interactive elements that facilitate real-time (or near real-time) interaction and communication with one or more users during the code review and/or deviation management procedures. According to embodiments, the module 114 (or the one or more GUIs generated thereby) may receive the source code 120 from the first UE 150 via the one or more GUIs, present information associated with the code review (e.g., the result of code review, the violated coding rule, the portion of code that violates the coding rule, etc.), present information associated with the deviation management (e.g., the option(s) of code modification for avoiding coding rule violation, the option(s) of modification on an existing deviation report, the option(s) of rule deviation, etc.), present a notification to request the one or more users to provide supplemental information, and receive one or more user feedbacks (e.g., user's approval or rejection on the presented option, user's comments or queries, user's supplementation on requested information, user's explanation about the reasoning that the rule violation is hard to be fixed, user's explanation about the background of user's current design and implementation, etc.)

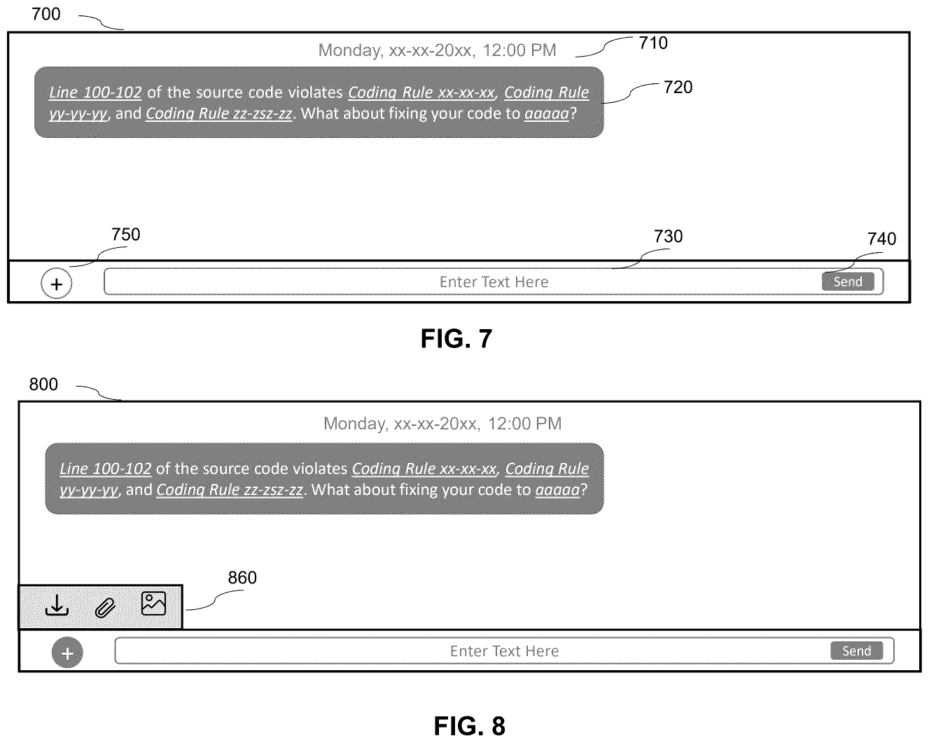

By utilizing and implementing the module 114, one or more GUIs may be generated and presented as the communication channel between the system 110 and the one or more users (e.g., the first user of the first UE 150, the second user of the second UE 160, etc.), thereby providing intuitive and interactive code review and deviation management procedures. Examples of the GUIs generated and presented by the module 114 are described below with reference to FIG. 7 to FIG. 9B.

The deviation management module 116 (or a component configured to implement the module 116) may be configured to perform one or more operations to manage one or more deviation reports associated with one or more coding rule deviations (identified by the module 112).

According to embodiments, the module 116 may provide a deviation report template to the module 112, such that the module 112 may utilize the deviation report template to create a new deviation report when required. The deviation report template may outline the structure and content requirement of a deviation report, and may include placeholders or default parameters that can be filled with specific details of each rule violation and the associated deviation. Upon detecting a coding rule violation, the module 116 (or any other component or module that utilizes the deviation report template to create the new deviation report) may obtain the relevant information (e.g., new deviation ID, ID of violated coding rule(s), ID of related deviation, information of user in charge, reason of deviation, information of deviation risk, information about how the risk of the deviation can be controlled and mitigated, etc.) from the module 112, and then populate the corresponding sections of the report template with the obtained information, thereby creating the new deviation report. According to embodiments, the new deviation ID is assigned by the module 112 and the relevant information may be extracted or generated by the module 112 (e.g., based on one or more user feedbacks), said new deviation ID and relevant information may then be provided to the module 116 along with an instruction for creating the new deviation report. Alternatively, the module 112 may provide the relevant information to the module 116 along with the instruction for creating the new deviation report, and the module 116 may assign the new deviation ID when creating the new deviation report.

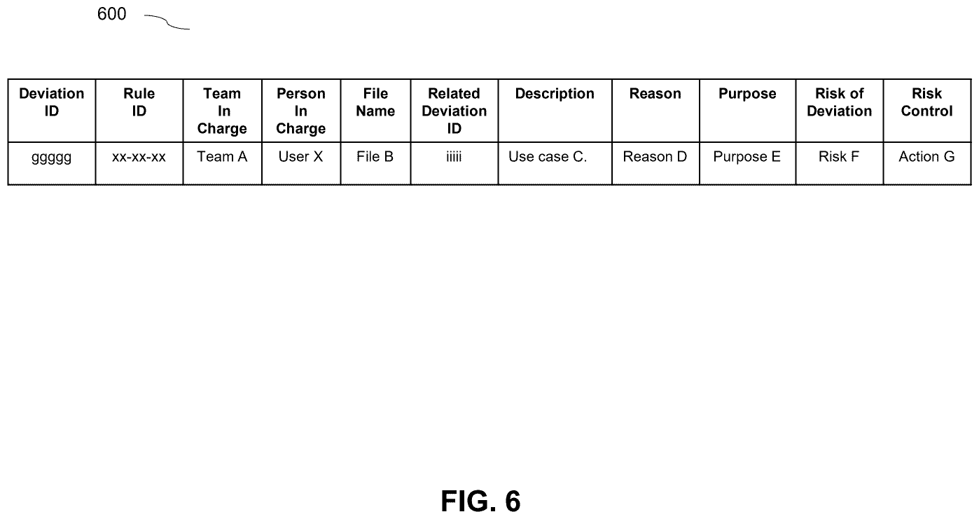

The deviation report may serve as a structured and organized document that presents information about a coding rule deviation and other relevant details to the associated users or stakeholders. The deviation report may also provide a summary or overview of one or more rule deviations. According to embodiments, a deviation report may include information of multiple rule deviations. An example deviation report is described below with reference to FIG. 6.

According to embodiments, the module 116 may retrieve, from the deviation management database 118, an existing deviation report and may update the deviation report based on information provided by the module 112. Alternatively or additionally, the module 116 may provide the stored deviation report to the module 112 such that the module 112 may update the stored deviation report thereafter. It is contemplated that, in some embodiments, the module 112 may directly communicate with the database 118 to retrieve the stored deviation report, update the stored deviation report, and store the updated deviation report to the database 118 thereafter, without departing from the scope of the present disclosure.

According to embodiments, the module 116 may store one or more deviation reports to the database 118. For instance, the module 116 may receive a new deviation report and/or an updated deviation report from the module 112 and then store the new deviation report/updated deviation report to the database 118. Similarly, the module 116 may store a new deviation report and/or an updated deviation report processed by the module 116 into the database 118.

According to embodiments, the module 116 may be configured to facilitate communication or interaction with the second user associated with the second UE 160. Specifically, the module 116 may generate and present, to the second user via the second UE 160, one or more UIs (e.g., GUIs, etc.) including information of a deviation report, such as information of a new deviation report, information of a modified deviation report, and the like. Further, the module 116 may receive one or more feedbacks from the second user via the presented UIs, such as a rejection on the new/modified deviation report, an approval on the new/modified deviation report, a request for supplemental information, and the like.

According to embodiments, the module 116 may communicatively couple to the module 114 (e.g., coupled to the module 114 via the module 112, directly coupled to the module 114, etc.), and may interoperate with the module 114 to generate and present the one or more UIs to the second UE 160. Alternatively or additionally, the module 116 may have another UI module (or operations associated with the generation and presentation of UIs) implemented therewith.

The deviation management database 118 (or a component configured to implement the database 118) may include one or more storage mediums or repositories that may be configured to store one or more deviation reports (e.g., new deviation report, modified deviation report, etc.) For instance, the database 118 may be configured to receive the one or more deviation reports from the module 116 and/or the module 112, and then store the received deviation report(s) thereafter. Further, the database 118 may be configured to, in response to a request from the module 116 and/or the module 112, retrieve one or more deviation reports associated with the request and provide the retrieved one or more deviation reports to the module 116 and/or the module 112. In some embodiments, the deviation management database 118 may store the one or more deviation reports in a relational database (RDB). In some embodiments, the deviation management database 118 may store the one or more deviation reports in a table format such as spreadsheet, comma-separated values (CSV), and the like.

The first user equipment (UE) 150 and the second UE 160 may each be associated with a respective user. For instance, the first UE 150 may be associated with a first user managing the source code 120 (e.g., a software engineer, a test engineer, etc.), while the second UE 160 may be associated with a second user managing the coding rule 130 (e.g., a rule committee member, a manager of the first user, etc.). The UE 150 and the UE 160 may include one or more devices or equipment that allow the respective user to access the system 110. For instance, each of the UE 150 and UE 160 may include a computing device (e.g., a desktop computer, a laptop computer, a tablet computer, a handheld computer, a smart speaker, a server, etc.), a mobile device (e.g., a smartphone, etc.), a SIM-based device, or any other suitable device which may be associated with the one or more users. Further, the first UE 150 and/or the second UE 160 may include, for example, a workstation, a software testing system, a software development system, and the like.

According to embodiments, the first UE 150 may enable the associated user (e.g., the first user) to submit or upload the source code 120 to the module 112 (e.g., via the one or more GUIs generated and presented by the module 114, etc.), receive information associated with the code review performed by the module 112 (e.g., the result of code review, violated coding rule(s), portion(s) of source code that violate the coding rule(s), etc.), receive information associated with the deviation management (e.g., option(s) of code modification for avoiding rule violation and coding rule deviation, option(s) for rule deviation report modification, option(s) of rule deviation, etc.), provide one or more user feedbacks (e.g., approval on the presented option(s), supplementation on required information, user's explanation about the reasoning that the presented options are hard to be applied, user's explanation about the background of user's current design and implementation, etc.) to the module 112 (e.g., via the one or more GUIs generated and presented by the module 114, etc.), and the like.

Similarly, the second UE 160 may enable the associated user (e.g., the second user) to receive information or application associated with deviation management (e.g., new deviation report, modification on an existing deviation report, etc.), provide one or more user feedbacks (e.g., approval on the new deviation report, comments on the modification on the existing deviation report, request for supplemental information, etc.) to the module 116, and the like.

The code management system 140 (or a component configured to implement the system 140) may include a code repository, a code version control system (VCS), a code distributed version control system (DVCS), a Continuous Integration/Continuous Deployment (CI/CD) system, and any other suitable equipment that may be configured to manage one or more codes (e.g., source code 120, etc.) analyzed and outputted by the system 110. For example, in some embodiments, the code management system 140 may include GitHub®, GitLab®, and the like.

The communication among the system 110, the system 140, the first UE 150, and/or the second UE 160 may be performed through one or more wired communications and/or one or more wireless communications. For example, the communication may be performed via one or more of: a cellular network (e.g., a fifth generation (5G) network, a sixth generation (6G) network, a long-term evolution (LTE) network, a third generation (3G) network, a code division multiple access (CDMA) network, etc.), a public land mobile network (PLMN), a local area network (LAN), closed area network (CAN), a wide area network (WAN), a metropolitan area network (MAN), a telephone network (e.g., a Public Switched Telephone Network (PSTN)), a private network, an ad hoc network, an intranet, the Internet, a fiber optic-based network, or the like.

In view of the above, example embodiments of the present disclosure provide a system that automatically analyzes or reviews a source code, and then identifies whether or not the source code violates any coding rule and whether or not any deviation management is required, before outputting the source code to the code management system. Further, the system of example embodiments may facilitate interactive and real-time (or near real-time) communication with the associated users (e.g., software engineer, coding rule management member, etc.) throughout the code reviewing and deviation management procedures. Furthermore, the system of example embodiments may intelligently suggest viable code modification(s), deviation report modification(s), and/or creation of new deviation report(s), according to the real-time condition(s) and the user-feedback(s).

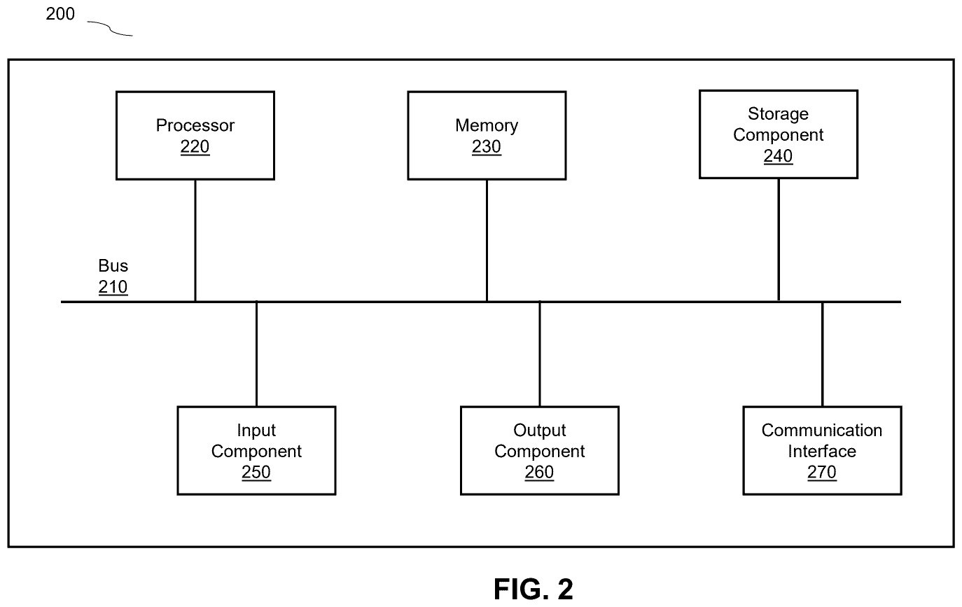

FIG. 2 illustrates example components of a code and deviation management system 200 (“the system 200” hereinafter), according to one or more embodiments. The system 200 in FIG. 2 may correspond to the system 110 in FIG. 1, thus it is contemplated that features described herein with reference to the system 110 and the system 200 may be applicable to each other, unless being explicitly described otherwise. Further, one or more components of the system 110 (e.g., modules 112-116 and database 118) may be implemented by one or more components of the system 200.

Referring to FIG. 2, the system 200 may include at least one bus 210, at least one processor 220, at least one memory 230, at least one storage component 240, at least one input component 250, at least one output component 260, and at least one communication interface 270. It is contemplated that the system 200 may include more or less components than illustrated in FIG. 2, without departing from the scope of the present disclosure. For instance, in some embodiments, components 250-260 may be optional and may be excluded from the system 200, a plurality of storage components 240 may be included, and the like.

The at least one bus 210 may include one or more components that permit communication among the components of system 200. The at least one processor 220 may be implemented in hardware, firmware, or a combination of hardware and software. According to embodiments, the processor 220 may include a central processing unit (CPU), a graphics processing unit (GPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component. In some implementations, the processor 220 may include one or more processors capable of being programmed to perform one or more operations described herein.

The at least one memory 230 may include a random access memory (RAM), a read-only memory (ROM), and/or another type of dynamic or static storage device (e.g., a flash memory, a magnetic memory, and/or an optical memory) that stores information and/or instructions for use by the processor 220. The at least one storage component 240 may store information and/or software related to the operation and use of the system 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. According to embodiments, the storage component 240 may be configured to store computer-readable or computer-executable instructions for implementing one or more modules of the system (e.g., LLM module, UI module, deviation management module, etc.), one or more AI/ML models for implementing the LLM module, one or more coding rules, and/or the like, and may provide the stored information to the memory 230 for the execution or utilization of the processor 220 when required.

The at least one input component 250 may include one or more components that enable the system 200 to receive information such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). The at least one output component 260 may include one or more components that provide output information from the system 200 (e.g., a display, a speaker, and/or one or more light-emitting diodes (LEDs)). In some embodiments, the input component 250 and the output component 260 may be combined into one component which is capable to receive information and output information.

The at least one communication interface 270 may include a transceiver-like component (e.g., a transceiver and/or a separate receiver and transmitter) that enables the system 200 to communicate with other devices, such as via a wired connection, a wireless connection, or a combination of wired and wireless connections. Communication interface 270 may permit system 200 to receive information from another device (e.g., one or more UEs, a component configured to implement a code management system, etc.) and/or provide information to said another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 270 may include at least one input/output (I/O) interface, at least one network interface, and at least one storage interface, or the like, that enable the components 220-260 to communicate with other devices. Further, the communication interface 270 may include one or more application programming interfaces (APIs) that allow the system 200 (or one or more components included therein) to communicate with one or more software applications (e.g., software application implemented in one or more UEs, software application implemented in the code management system, etc.)

System 200 may perform one or more operations described herein in response to the at least one processor 220 executing computer-executable instructions for implementing one or more of the components 112-118 in FIG. 1. These computer-executable instructions may be stored by a non-transitory computer-readable recording medium, such as memory 230 and/or storage component 240. A computer-readable medium is defined herein as a non-transitory memory device. A memory device may include memory space within a single physical storage device or memory space spread across multiple physical storage devices.

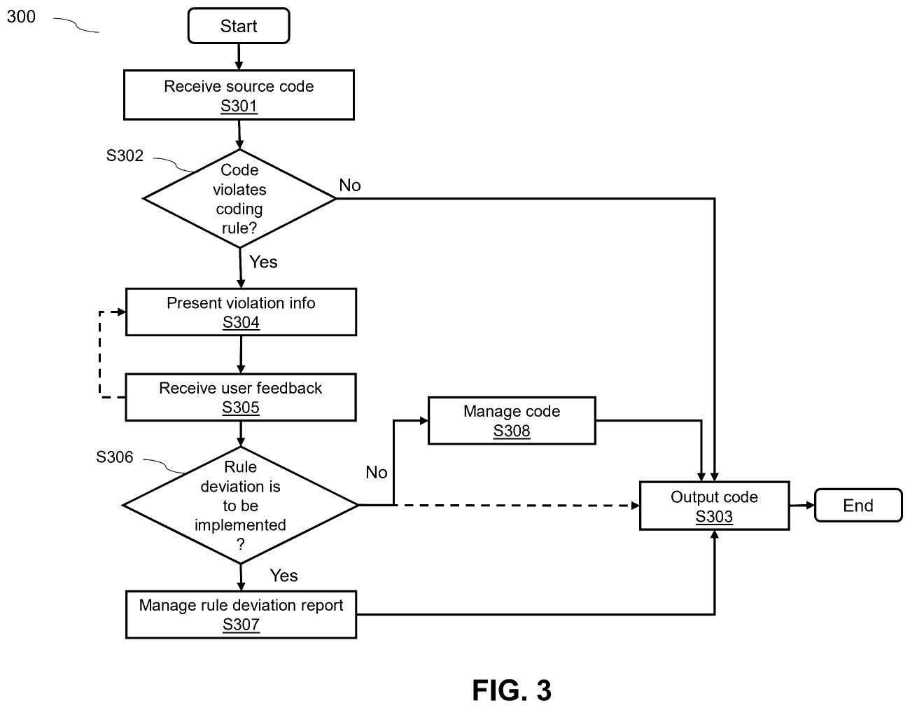

According to embodiments, computer-executable instructions (e.g., software instructions, etc.) may be read into memory 230 and/or storage component 240 from another computer-readable medium or from another device via the communication interface 270. When executed, the computer-executable instructions stored in memory 230 and/or storage component 240 may cause the processor 220 to perform one or more processes or operations described herein. Additionally, or alternatively, hardwired circuitry may be used in place of or in combination with software instructions to perform one or more processes described herein. Thus, implementations described herein are not limited to any specific combination of hardware circuitry and software. Example operations that may be performed by the system of example embodiments are described in the following with reference to FIG. 3 to FIG. 9B.

FIG. 3 illustrates a flow diagram of an example method 300 for reviewing a source code and performing one or more operations based thereon, according to one or more embodiments. One or more operations of method 300 may be performed by at least one processor (e.g., processor 220 in FIG. 2) of the system of example embodiments. For instance, the at least one processor may execute at least the LLM module (or computer-executable instructions for implementing the LLM) to perform one or more operations described herein.

Referring to FIG. 3, at operation S301, the at least one processor may be configured to receive at least one source code. For instance, the at least one processor may receive a source code (e.g., source code 120 in FIG. 1) from a first user (e.g., a software engineer). According to embodiments, the at least one processor may receive the source code from a user equipment (e.g., first UE 150). According to embodiments, the at least one processor may receive the source code from one or more GUIs presented to the first user. Alternatively or additionally, the at least one processor may receive the source code via an input component (e.g., input component 250 in FIG. 2).

Upon receiving the source code, the method 300 may proceed to operation S302, at which the at least one processor may be configured to determine whether or not the source code violates at least one coding rule. For instance, the at least one processor may determine at least one coding rule (e.g., coding rule 130) associated with the received source code and may obtain the at least one coding rule (e.g., from a repository storing the at least one coding rule, from an associated UE, etc.) thereafter. Subsequently, the at least one processor may compare the source code with the at least one coding rule to determine whether or not the source code violates one or more requirements or conditions defined in the at least one coding rule.

According to embodiments, the at least one processor may be configured to perform a static code analysis on the source code. For instance, the at least one processor may parse or break down the source code into individual information (e.g., statements, tokens, expressions, etc.), thereby summarizing the source code into one or more abstract syntax trees (ASTs) (or any other suitable information representation structure). Subsequently, the at least one processor may traverse the one or more ASTs and check each node in the ASTs with reference to the at least one coding rule to identify the potential violation. In this way, the at least one processor may determine one or more requirements or conditions defined in the at least one coding rule and may scan through the source code to identify any portion or occurrence that matches the one or more requirements or conditions.

Based on determining that the source code does not violate the at least one coding rule, the method 300 may proceed to operation S303, at which the at least one processor may be configured to output the source code. For instance, the at least one processor may output the source code to a code management system (e.g., system 140 in FIG. 1) for further processing, without modifying the source code. In this case, the at least one processor may further generate and provide a notification to the first user to notify the first user about the completion of the code analysis and uploading of the source code without coding rule violation or deviation. The method 300 may be terminated thereafter. In another embodiment, based on determining that the source code does not violate the at least one coding rule, the at least one processor may simply notify the associate user regarding the same, without outputting the source code to the code management system.

On the other hand, based on determining that the source code violates the at least one coding rule, the method 300 may proceed to operation S304, at which the at least one processor may be configured to present information associated with the violation of the at least one codling rule to the first user.

The violation information may include the nature of the violation (e.g., code formatting violation, security practice violation, etc.), the portion of the source code that violates the coding rule (e.g., line number, a code context that causes the violation, etc.), a description of the violated coding rule (e.g., name of the coding rule, type of coding rule, etc.), an option of code modification for avoiding the violation (if available), an option of modification on an existing deviation report for addressing the violation (if available), a notification that the creation of a new deviation is unavoidable, a request for supplemental information, and/or any other suitable information.

According to embodiments, the at least one processor may be configured to generate at least one GUI. The at least one GUI may include at least one chat window and at least one interactive element, while the at least one chat window may include the violation information and the at least one interactive element may allow the first user to interact with the GUI. Subsequently, the at least one processor may be configured to present the at least one GUI to the first user via the associated UE (e.g., the first UE 150), thereby presenting the violation information to the first user. Example GUIs according to embodiments are described below with reference to FIG. 7 to FIG. 9B.

Upon presenting the violation information, the method may proceed to operation S305, at which the at least one processor may be configured to receive, from the first user, at least one user feedback associated with the presented information (“first user feedback” hereinafter). The first user feedback may include information that utilized by the at least one processor to determine whether or not at least one rule deviation is to be implemented.

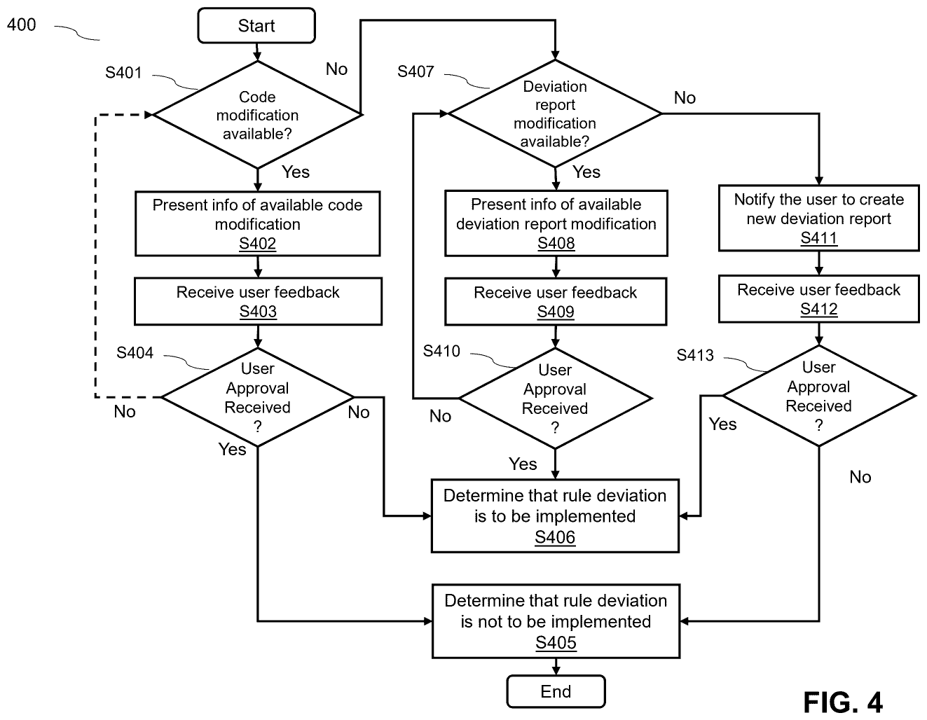

For instance, the violation information (presented by the at least one processor at operation S304) may include information of at least one code modification to avoid the violation. In this case, the first user feedback (received by the at least one processor at operation S305) may include an approval or a rejection on the presented at least one code modification, a question or query of the first user regarding the presented information and/or the coding rule violation, supplemental information that may be utilized for re-determination of suitable code modification, the reasoning that the code modification is not acceptable (if the modification is not acceptable), the information about the background of the current design and the implementation, the information about the constraint of the design and the implementation, and the like. An example embodiment associated therewith is described below with reference to FIG. 4.

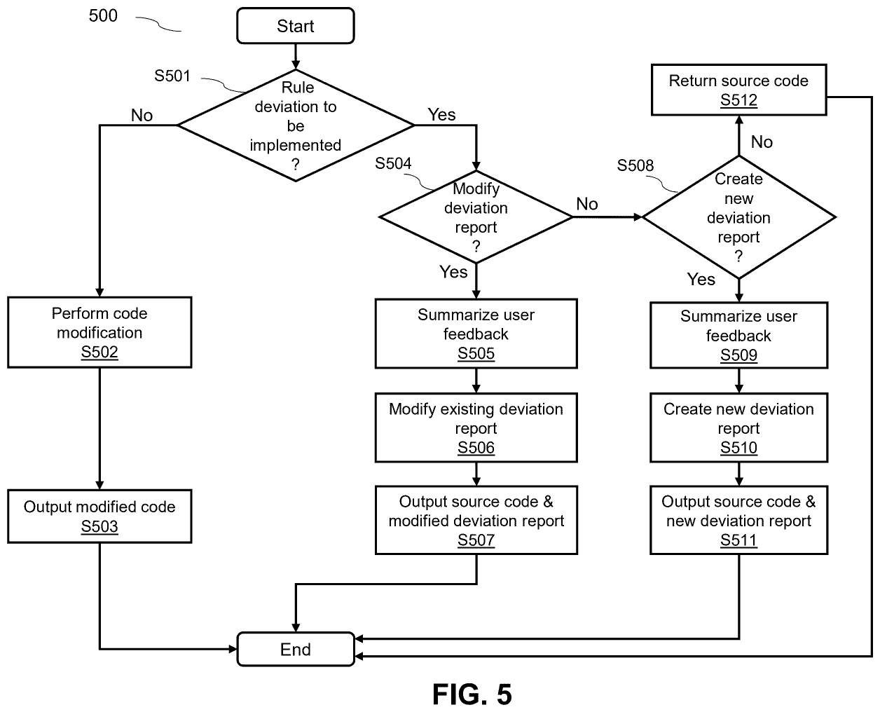

As another example, the violation information (presented by the at least one processor at operation S304) may include information of at least one modification on at least one existing deviation report (“deviation report modification” herein) to avoid the violation. In this case, the first user feedback (received by the at least one processor at operation S305) may include an approval or a rejection on the at least one deviation report modification, a question or query of the first user regarding the presented information and/or the associated deviation report, supplemental information that may be utilized for re-determination of suitable deviation report modification, and the like. An example embodiment associated therewith is described below with reference to FIG. 5.

In some embodiments, upon receiving user feedback, the method 300 may return to operation S304, at which the at least one processor may be configured to present additional information. For instance, the at least one processor may evaluate the first user feedback (and any supplemental information if available), re-determine additional or alternative solutions (e.g., code modification, deviation report modification, etc.) to address the coding rule violation based on the evaluation, and updating the at least one GUI to include the information of the additional/alternative solution. In the event that the obtained information is insufficient, the at least one processor may notify the user to request for supplemental information. Accordingly, a feedback loop may be formed and be repeated until one or more pre-defined conditions are satisfied. For example, the at least one processor may proceed to the next step when sufficient information is obtained, when the number of loops exceeds a threshold value, when determining that the user has requested creating a deviation report via the GUI, and the like.

It is contemplated that operations S304 and S305 (e.g., generation and presentation of the at least one GUI, receiving the first user feedback) may be performed by the at least one processor upon executing a UI module (or computer-executable instructions for implementing the UI module), and/or the at least one processor may instruct another component (e.g., another processor that is executing or implementing the UI module, an output component of the system, an input component of the system, etc.) to perform operations S304 and S305, without departing from the scope of the present disclosure.

Referring still to FIG. 3, at operation S306, the at least one processor may be configured to determine whether or not at least one rule deviation is to be implemented. Further descriptions of operations associated therewith are provided below with reference to FIG. 4.

Based on determining that at least one rule deviation is to be implemented, the method 300 may proceed to operation S307, at which the at least one processor may be configured to perform at least one operation to manage at least one rule deviation report according to the first user feedback. Example operations associated therewith are described below with reference to FIG. 5. Subsequently, the method 300 may proceed to operation S303, at which the at least one processor may output the source code to the code management system. In some embodiment, when determining that at least one rule deviation is to be implemented without modifying the code, the at least one processor may skip the outputting of the source code to the code management system.

On the other hand, based on determining that the at least one rule deviation is not to be implemented, the method 300 may proceed to operation S308, at which the at least one processor may be configured to perform at least one operation to manage the source code to address the violation. For instance, the at least one processor may apply one or more code modifications to modify the code, thereby overcoming the violation of the at least one coding rule. Subsequently, the method 300 may proceed to operation S303, at which the at least one processor may output the modified source code to the code management system.

Alternatively, based on determining that the at least one rule deviation is not to be implemented, the method 300 may proceed directly to operation S303, without performing operation S308. For instance, the at least one processor may determine that no code modification for avoiding the coding rule violation is available, the user has rejected all available code modification(s), the user would not like to implement any coding rule deviation, or the like. In that case, the at least one processor may output the source code to the device (e.g., the first UE) of the first user, thereby returning the source code to the original user without modifying the source code or outputting the source code to the code management system. Alternatively, the at least one processor may simply notify the user regarding the user regarding the same, and may skip the outputting of the source code to the user device and/or the code management system.

Referring next to FIG. 4, which illustrates a flow diagram of an example method 400 for determining whether or not at least one rule deviation is to be implemented, according to one or more embodiments.

One or more operations in method 400 of FIG. 4 may be part of one or more operations in method 300 of FIG. 3. For instance, operations S402, S408, and S411 in method 400 may be part of operation S304 in method 300, operations S403, S409, and S412 in method 400 may be part of operation S305 in method 300, and operation S404-S406, S410, and S413 in method 400 may be part of operation S306 in method 300. In this regard, it can be understood that one or more operations in method 400 may also be performed by the at least one processor of the system provided by the example embodiments, upon executing or implementing at least the LLM module (or upon executing computer-executable instructions for implementing the LLM module). Further, the method 400 may be performed based on determining that a source code received by the at least one processor (at operation S301) violates at least one coding rule.

As illustrated in FIG. 4, at operation S401, the at least one processor may be configured to determine whether or not at least one code modification for modifying the source code to avoid violation of the at least one coding rule is available. For instance, based on determining that the source code violates the at least one coding rule, the at least one processor may categorize the detected violation(s) based on the nature of the violation, the severity of the violation, and the like. Accordingly, the at least one processor may determine, from a set of predefined code modifications, whether or not a code modification for correcting the source code to avoid or address the violation is available. According to embodiments, the set of predefined code modifications may be included in one or more action books, wherein the one or more action books may be stored in a repository or a storage medium (e.g., storage component 240 in FIG. 2, etc.) and may be retrieved by the at least one processor when required. The one or more action books may be continuously (or periodically) updated based on, for example, the latest industry practices, feedback from users, and the like.

According to embodiments, the at least one processor may determine the available code modification taking into consideration the specific context of the source code, the comments included in the source code, the documents associated with the source codes, the modification history (if any), the project requirements, the user information, the user feedback, and the like, thereby providing customized or tailored recommendations on the code modification to the user.

Based on determining that the at least one code modification is not available, the method 400 may proceed to operations S407 (further described below after the descriptions of operations S402-S406). On the other hand, based on determining that the at least one code modification is available, the method 400 may proceed to operation S402, at which the at least one processor may be configured to present information of the at least one code modification to the first user.

Subsequently, at operation S403, the at least one processor may be configured to receive at least one user feedback from the first user. The at least one user feedback may be similar to the first user feedback described above with reference to FIG. 3, and may include an approval on the at least one code modification, a rejection on the at least one code modification, a question or query of the first user, supplemental information that may be utilized for re-determination of additional or alternative code modification, and the like.

The specific procedures of operations S402 and S403 may be similar to the operations of presenting the violation information (operation S304) in FIG. 3 and receiving the first user feedback (operation S305) in FIG. 3, respectively. For instance, the at least one processor may execute or implement a UI module (or execute computer-executable instructions for implementing the UI module) to generate and present at least one GUI including the information of the at least one code modification, and then receive the at least one user feedback from the first user via the at least one GUI. Alternatively or additionally, the at least one processor may instruct another component (e.g., another processor that executes or implements the UI module, an output component of the system, an input component of the system, etc.) to perform operations S402 and S403 in a similar manner, without departing from the scope of the present disclosure. Example GUIs associated therewith are described below with reference to FIG. 7 to FIG. 9B.

Next, at operation S404, the at least one processor may be configured to determine whether the user feedback (e.g., the first user feedback received at operation S403) includes the approval or the rejection on the at least one code modification (presented to the first user at operation S402). Based on determining that the user feedback includes the approval, the method 400 may proceed to operation S405, at which the at least one processor may determine that the at least one rule deviation is not to be implemented. On the other hand, based on determining that the user feedback includes the rejection, the method 400 may proceed to operation S406, at which the at least one processor may determine that the at least one rule deviation is to be implemented.

According to embodiments, based on determining that the user feedback includes the rejection, the method 400 may return to operation S402, at which the at least one processor may be configured to re-determine, based on the user feedback, one or more additional or alternative code modifications for addressing the coding rule violation. Subsequently, the at least one processor may present the information of the information of the one or more additional/alternative code modifications, and then receive further user feedback from the first user.

Referring still to FIG. 4, based on determining that no code modification is available (at operation S401), the method 400 may proceed to operation S407, at which the at least one processor may be configured to determine whether or not at least one deviation report modification is available. Specifically, the at least one processor may determine whether or not at least one existing deviation report associated with the at least one rule deviation is available, and based on determining that the at least one existing deviation report is available, the at least one processor may further determine whether or not the existing deviation report can be modified to avoid the violation of the at least one coding rule. Accordingly, based on determining that the existing deviation report can be modified to avoid the violation of the at least one coding rule, the at least one processor may determine that the at least one deviation report modification is available. Otherwise, the at least one processor may determine that no deviation report modification is available.

Based on determining that the at least one deviation report modification is available, the method 400 may proceed to operation S408, at which the at least one processor may be configured to present the information associated with the at least one deviation report modification to the first user. Subsequently, at operation S409, the at least one processor may be configured to receive at least one user feedback from the first user. The at least one user feedback may be similar to the first user feedback described above with reference to FIG. 3, and may include an approval on the at least one deviation report modification, a rejection on the at least one deviation report modification, a question or query of the first user, supplemental information that may be utilized for re-determination of additional or alternative deviation report modification, and the like.

The specific procedures of operations S408 and S409 may be similar to the operations of presenting the violation information (operation S304) in FIG. 3 and receiving the first user feedback (operation S305) in FIG. 3, respectively. For instance, the at least one processor may execute or implement a UI module (or execute computer-executable instructions for implementing the UI module) to generate and present at least one GUI including the information of the at least one deviation report modification, and then receive the at least one user feedback from the first user via the at least one GUI. Alternatively or additionally, the at least one processor may instruct another component (e.g., another processor that executes or implements the UI module, an output component of the system, an input component of the system, etc.) to perform operations S408 and S409 in a similar manner, without departing from the scope of the present disclosure. Example GUIs associated therewith are described below with reference to FIG. 7 to FIG. 9B.

Next, at operation S410, the at least one processor may be configured to determine whether the user feedback (e.g., the first user feedback received at operation S409) includes the approval or the rejection on the at least one deviation report modification (presented to the first user at operation S408). Based on determining that the user feedback includes the approval, the method 400 may proceed to operation S406 at which the at least one processor may determine that the at least one rule deviation is to be implemented. On the other hand, based on determining that the user feedback includes the rejection, the method 400 may return to operation S407, at which the at least one processor may be configured to re-determine, based on the user feedback, one or more additional or alternative deviation report modifications for addressing the coding rule violation. Subsequently, the at least one processor may present the information of the information of the one or more additional/alternative deviation report modifications, and then receive further user feedback from the first user.

Referring still to FIG. 4, based on determining that no deviation report modification is available, the method 400 may proceed to operation S411, at which the at least one processor may be configured to notify the user that the creation of a new deviation report (or an application for a new deviation report) is required. For instance, the at least one processor may generate and present one or more notifications including the reasoning of why the new deviation report is required. According to embodiments, the notification may include a request for supplemental information required for creating the new deviation report.

Upon presenting the notification to notify the user to create a new deviation report, the method 400 may proceed to operation S412, at which the least one processor may be configured to receive at least one user feedback from the first user. The at least one user feedback may be similar to the first user feedback described above with reference to FIG. 3, and may include an approval on the creation of the new deviation report, a rejection on the creation of the new deviation report, a question or query of the first user, supplemental information requested for creating the new deviation report, and the like.

The specific procedures of operations S411 and S412 may be similar to the operations of presenting the violation information (operation S304) in FIG. 3 and receiving the first user feedback (operation S305) in FIG. 3, respectively. For instance, the at least one processor may execute or implement a UI module (or execute computer-executable instructions for implementing the UI module) to generate and present at least one GUI including the notification for creating the new deviation report, and then receive the at least one user feedback from the first user via the at least one GUI. Alternatively or additionally, the at least one processor may instruct another component (e.g., another processor that executes or implements the UI module, an output component of the system, an input component of the system, etc.) to perform operations S411 and S412 in a similar manner, without departing from the scope of the present disclosure. Example GUIs associated therewith are described below with reference to FIG. 7 to FIG. 9B.

Next, at operation S413, the at least one processor may be configured to determine whether the user feedback (e.g., the first user feedback received at operation S412) includes the approval or the rejection on the creation of the new deviation report. Based on determining that the user feedback includes the approval, the method 400 may proceed to operation S406 at which the at least one processor may determine that the at least one rule deviation is to be implemented. On the other hand, based on determining that the user feedback includes the rejection, the method 400 may proceed to operation S405, at which the at least one processor may determine that the at least one rule deviation is not to be implemented.

To this end, the system of example embodiments may appropriately determine whether or not at least one rule deviation is to be implemented, based on real-time conditions and communications with the associated user. Upon determining whether or not the at least one rule deviation is to be implemented, the system may perform one or more operations to appropriately respond to the violation of the coding rule.

FIG. 5 illustrates a flow diagram of an example method 500 for determining at least one operation for responding to a coding rule violation, according to one or more embodiments.

One or more operations in method 500 of FIG. 5 may be part of one or more operations in method 300 of FIG. 3 and method 400 of FIG. 4. For instance, operations S501 in method 500 may include the operations in method 400, operation S502 in method 500 may be similar to operation S308 in method 300, operations S504-S506 and S508-S511 in method 500 may be part of operation S307 in method 300, operations S503, S507, and S511-S512 in method 500 may be part of operation S303 in method 300, and the like. In this regard, it can be understood that one or more operations in method 500 may also be performed by the at least one processor of the system provided by the example embodiments, upon executing or implementing at least the LLM module (or upon executing computer-executable instructions for implementing the LLM module).

Referring to FIG. 5, at operation S501, the at least one processor may be configured to determine whether or not at least one rule deviation is to be implemented. Specifically, the at least one processor may perform one or more operations of method 400 to determine whether or not the at least one rule deviation should be implemented.

Based on determining that the at least one rule deviation is not to be implemented, the method 500 may proceed to operation S502, at which the at least one processor may be configured to perform at least one code modification. Specifically, the at least one processor may modify, based on at least one code modification (e.g., determined at operation S401 and approved by the first user at operation S403-S404), the portion(s) of the source code that violates the coding rule, thereby addressing the violation. Subsequently, at operation S503, the at least one processor may be configured to output the modified code to a code management system (e.g., system 140 in FIG. 1). According to embodiments, the at least one processor may further generate and provide a notification to the first user to notify the first user about the completion of the code analysis and uploading of the source code without coding rule violation or deviation.

On the other hand, based on determining that the at least one rule deviation is to be implemented, the method 500 may proceed to operation S504, at which the at least one processor may be configured to determine whether or not an existing deviation report should be modified. Based on determining that modification on the existing deviation report is required, the method 500 may proceed to operation S505. Otherwise, based on determining that the modification on the existing deviation report is not required, the method 500 may proceed to operation S508.

At operation S505, the at least one processor may be configured to summarize the user feedback (e.g., received at operations S305, S403, and/or S409). According to embodiments, the at least one processor may track the conversation or communication between the first user and the system, and then analyze the conversation to capture the information required for modifying the existing deviation report therefrom. The conversation may be a single conversation or a multi-turns conversation. The at least one processor may identify one or more entities or specific aspects mentioned in the user feedback (e.g., identify mentions of source code, coding rules, coding rule violations, suggested modification, reason of deviation, purpose of deviation, risk of deviation, risk control and mitigation, etc.), and then extract the associated parameters from the user feedback.

Upon summarizing the user feedback, the method 500 may proceed to operation S506, at which the at least one processor may be configured to modify the existing deviation report. Specifically, the at least one processor may obtain the existing deviation report from a database (e.g., database 118 in FIG. 1) and then modify the existing deviation report to include information of the summarized user feedback.

FIG. 6 illustrates an example deviation report 600, according to one or more embodiments. In the example of FIG. 6, the deviation report 600 includes multiple sections or fields, such as: deviation ID (i.e., ID assigned to the deviation), rule ID (i.e., ID of the violated coding rule), team in charge, person in charge, file name (e.g., name of source code, name of associated document, etc.), related deviation ID, description (e.g., descriptions of the use case which requires deviation), reason of deviation, purpose of deviation, risk of deviation, and risk control.

According to embodiments, a portion of the information in the deviation report may be generated and obtained by the at least one processor and another portion of the information may be obtained via summarizing the user feedback. For instance, the deviation ID may be generated and assigned by the at least one processor, the rule ID and related deviation ID may be collected by the at least one processor based on the code analysis, the reason and purpose of deviation may be obtained from the summarized user feedback, and the like.

The deviation report may be stored, utilized, or generated in any suitable computer-readable format, such as (but not limited to) plain text file format, JavaScript Object Notation (JSON) format, YAML format, Extensible Markup Language (XML) format, or the like. Further, although it is illustrated that the information of the deviation report may be presented in table form, it can be understood that the information may be presented in any suitable form, without departing from the scope of the present disclosure. Furthermore, the deviation report may include any more or less information than as illustrated in FIG. 6. For instance, when multiple deviations are required for addressing the coding rule violation, the deviation report may include information of the multiple deviations (e.g., multiple deviation IDs, multiple rule IDs, etc.)

Referring back to FIG. 5, at operation S506, the at least one processor may determine, based on the summarized user feedback, which of the fields in the existing deviation report is required to be modified, and then modify or update one or more required fields according to the summary of the user feedback. For instance, the at least one processor may modify the field of “Rule ID” to reflect the ID of the coding rule violated by the source code, may add descriptions of a new use case to the field of “Description”, and the like.

Accordingly, at operation S507, the at least one processor may be configured to output the source code and the modified deviation report. For instance, the at least one processor may output the source code to the code management system (e.g., system 140 in FIG. 1), and store the modified deviation report to the database (e.g., database 118 in FIG. 1).

According to embodiments, before outputting the source code to the code management system and/or outputting the modified deviation report to the database, the at least one processor may output or provide the modified deviation report and/or the source code to a second user (e.g., a manager of the first user, a member of rule committee, etc.) for his/her review. Subsequently, the at least one processor may receive at least one user feedback from the second user (“second user feedback” herein). Accordingly, the at least one processor may store, in the database, the modified deviation report and the second user feedback. In some embodiments, the at least one processor may perform one or more operations (e.g., re-determine viable solutions to address the coding rule violation, communicate with the first user to convey the opinion of the second user, etc.) based on the second user feedback.

Referring still to FIG. 5, at operation S508, the at least one processor may be configured to determine whether or not a new deviation report should be created. Based on determining that the creation of the new deviation report is required, the method 500 may proceed to operation S509. Otherwise, based on determining that the creation of the new deviation report is not required, the method 500 may proceed to operation S512 at which the at least one processor may return the source code to the first user without modifying the source code or deviating any coding rule.

At operation S509, the at least one processor may be configured to summarize the user feedback (e.g., received at operations S305, S403, S409, and/or S412). The specific operation may be similar to operation S505, thus redundant descriptions associated therewith may be omitted below for conciseness.

Upon summarizing the user feedback, the method 500 may proceed to operation S510, at which the at least one processor may be configured to create a new deviation report. According to embodiments, the at least one processor may utilize a deviation report template to create a new deviation report. The deviation report template may outline the structure and content requirement of a deviation report, and may include placeholders or default parameters that can be filled with specific details of each rule violation and the associated deviation. For instance, a deviation report template may have sections or fields similar to those described above with reference to FIG. 6, while the content or parameter of each field may be empty or pre-filled with default parameters.

In this regard, the at least one processor may obtain the deviation report template (e.g., from a memory or a storage component), and then populate the corresponding sections or fields of the deviation report template with the summarized user feedback, thereby creating the new deviation report. For instance, the at least one processor may assign a new deviation ID and insert the new deviation ID into the field of “Deviation ID”, may extract the information associated with the reason of deviation from the summarized user feedback and insert the information into the field of “Reason”, and the like.

Accordingly, at operation S511, the at least one processor may be configured to output the source code and the new deviation report. For instance, the at least one processor may output the source code to the code management system (e.g., system 140 in FIG. 1), and store the new deviation report to the database (e.g., database 118 in FIG. 1).

According to embodiments, before outputting the source code to the code management system and/or outputting the new deviation report to the database, the at least one processor may output or provide the new deviation report and/or the source code to the second user for his/her review. Subsequently, the at least one processor may receive at least one second user feedback from the second user. Accordingly, the at least one processor may store, to the database, the new deviation report and the second user feedback. In some embodiments, the at least one processor may perform one or more operations (e.g., re-determine viable solutions to address the coding rule violation, communicate with the first user to convey the opinion of the second user, etc.) based on the second user feedback.

It is contemplated that the operations of FIG. 3 to FIG. 5 are merely provided for descriptive purposes, and the scope of the present disclosure should not be limited thereto. One or more operations may be excluded from method 300-method 500, one or more additional operations may be added to method 300-method 500, one or more operations of method 300-method 500 may be combined or be performed in parallel, and the like, without departing from the scope of the present disclosure. Specifically, when a source code violates multiple coding rules, the solution for addressing the violations may include the combination of source modification, deviation report modification, and new deviation report creation.

FIG. 7 to FIG. 9B illustrate example GUIs of an example use case, according to one or more embodiments. In the example use case, the system has detected that a source code violates three coding rules. As a result of multi-turns communication with the user, the system determines, based on multiple user feedbacks, that a viable solution for addressing the violations includes the combination of: (1) modifying the source code, (2) modifying existing deviation reports, and (3) creation of a new deviation report. Descriptions associated with FIG. 7 to FIG. 9B are provided in the following.

FIG. 7 illustrates a diagram of an example GUI 700, according to one or more embodiments. GUI 700 may be generated by at least one processor of the system (or any suitable component implementing the LLM module and UI module) of example embodiments and presented to one or more users, upon determining that the source code violates one or more coding rules.

As illustrated in FIG. 7, the GUI 700 may include a chat window and one or more interactive elements. The chat window may include information associated with the violation (e.g., information of the violated coding rules, information of the portions of source code that are violating the coding rules, information of potential code modification for addressing the violation, etc.), and the one or more interactive elements may enable the user to interact and communicate with the chat window to provide one or more user feedbacks. In the example of FIG. 7, the chat window includes information 710-720 and interactive elements 730-750.

The information 710 is associated with timing information (e.g., the timing at which the code review is completed, the timing at which the violation is detected, the timing at which the GUI 700 is presented to the user, etc.) The information 720 is associated with the violated coding rules, the portions of source code that violate the coding rules, and option(s) or recommendation(s) of a code modification to avoid the coding rule violations. According to embodiments, at least a portion of the information 720 may include one or more interactable or selectable texts, each of which may be associated with a violated coding rule, a specific portion of source code that violates the coding rules, and the option or recommendation of the code modification. The interactable/selectable texts may, upon interacted by the user, provide additional information to the user. For instance, upon detecting a user interaction with the selectable text “Coding Rule xx-xx-xx”, the system may update the GUI 700 to present portion(s) of the coding rule that is being violated, may retract the coding rule document and provide the same to the user, and the like. In the example GUIs, the interactable/selectable texts are presented differently from the non-interactable/non-selectable texts for illustrative purposes.

The interactive element 730 may include an input field 730 that is interactable by the user to provide feedback about the presented information. The interactive element 740 may include a button 740 which, when being interacted by the user, provides the user feedback to the system. The interactive element 750 may include a button 750 which, when being interacted by the user, presents additional interactive elements for enabling the user to perform one or more additional operations.

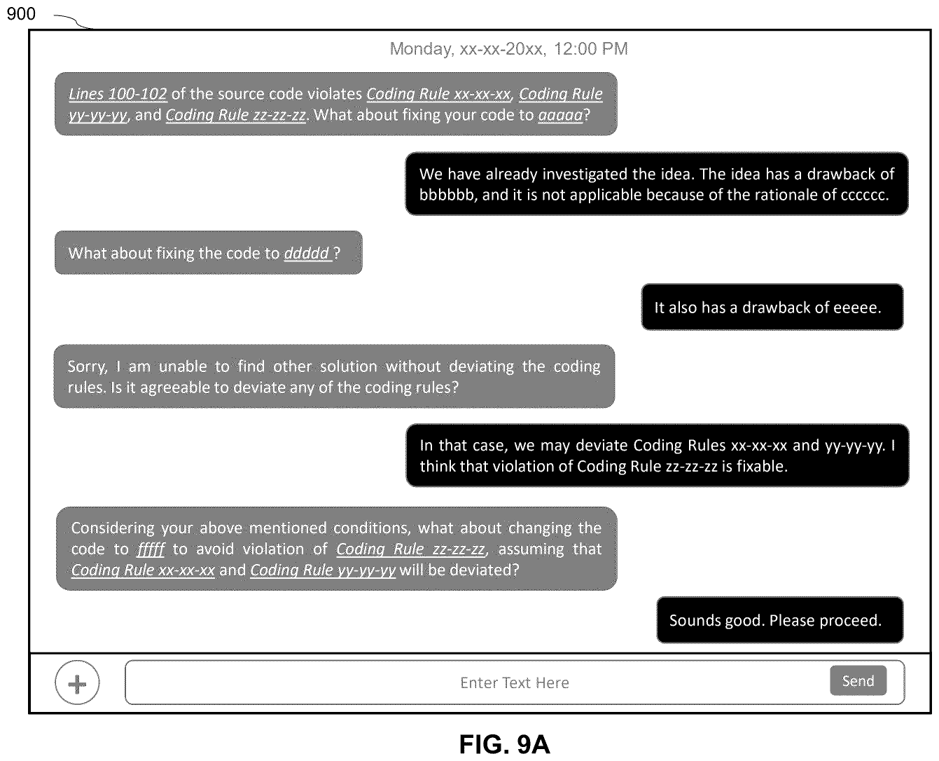

FIG. 8 illustrates a diagram of an example GUI 800, according to one or more embodiments. The GUI 800 is an updated version of the GUI 700, upon detecting a user interaction with the interactive element 750. In the example of FIG. 8, the GUI 800 may include a dropdown menu 860 that contains additional interactive components, such as a download button that allows the user to download at least a portion of the conversions presented in the GUI 800, a file attachment button that allows the user to attach one or more documents (e.g., source code, reference material, etc.) throughout the conversation or communication to supplement the required information, and an image attachment button that allows the user to attach one or more images to supplement the required information.

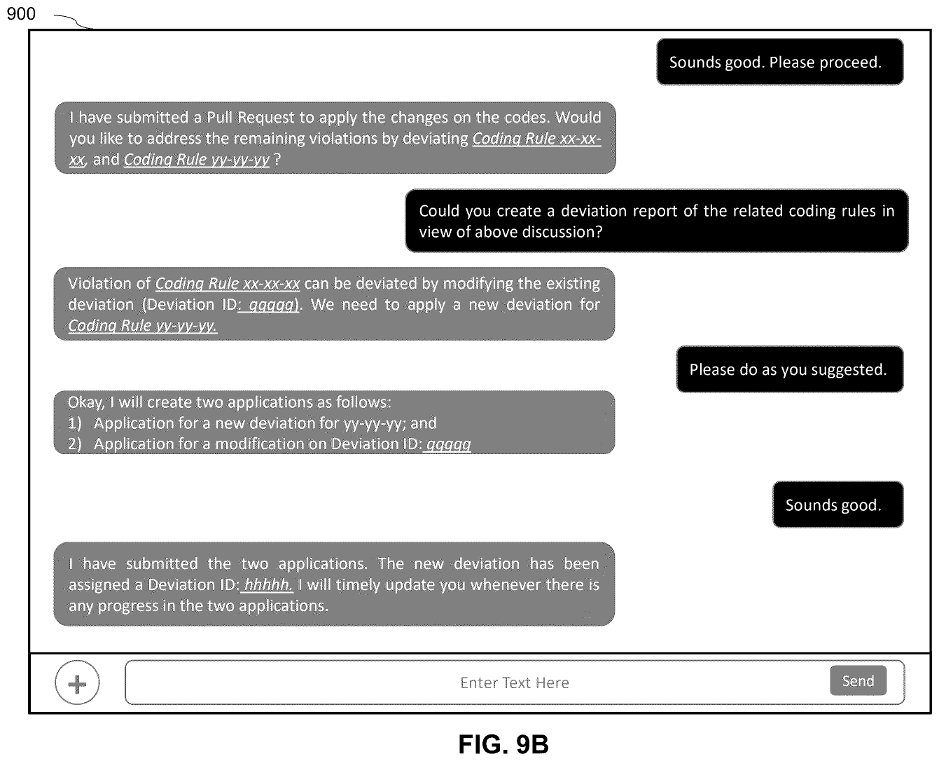

FIG. 9A and FIG. 9B illustrate an example GUI 900, according to one or more embodiments. The GUI 900 is an updated version of the GUI 700, including the multi-turn conversation between the user and the system throughout the procedures, from the detection of coding rule violations to the completion of the operations for addressing the violations. Descriptions of the example use case are provided in the following.

Referring to FIG. 9A, in the example use case, the system has identified that a portion of the source code (lines 100-102) has violated three coding rules (i.e., coding rule xx-xx-xx, coding rule yy-yy-yy, and coding rule zz-zz-zz), and has determined a potential code modification for addressing the violations. Accordingly, the system presents the associated information to the user via the GUI 900. Subsequently, the user provides feedbacks to the system via interacting with the GUI 900. In the example use case, the user feedback includes a rejection on the suggested code modification and reasons of the rejection.

Based on the reasons of the rejection, the system re-determines an alternative solution for addressing the violations and updates the GUI 900 to present the information of the alternative solution to the user. In the example use case, the system first determines an alternative code modification for addressing the violations, and further receive a user feedback including another rejection and the associated reason.

Based on the reason of the second rejection, the system determines that at least one rule deviation is required and updates the GUI 900 to notify the user regarding the same. Subsequently, the system receives a user feedback including the user intention to deviate only a portion of the violated rules. Accordingly, the system re-determines and presents a potential code modification, taken into consideration of the user intention and the conditions defined in the user feedback. The system then receives a user feedback including an approval to modify the source code according to the latest recommendation.

Referring to FIG. 9B, which illustrates the GUI 900 that includes the conversation between the user and the system, in continuation of the conversation the GUI 900 of FIG. 9A. As illustrated in FIG. 9B, after receiving the user approval, the system modifies the source code according to the approved code modification, and then notifies the user upon performing the code modification. The notification may include a reminder to address the remaining violations. Upon receiving a user feedback, the system determines that the remaining violations may be addressed by modifying an existing deviation report and creating a new deviation report. Accordingly, based on determining that the user agrees with the suggested solution, the system performs operations for modifying the existing deviation report and for creating the new deviation report. In some embodiments, the system may attach the file of the copy of the applied deviation report in text format, PDF format, and the like.

It is contemplated that the GUIs illustrated in FIG. 7 to FIG. 9B are merely examples of possible embodiments, and the scope of the present disclosure should not be limited thereto. Specifically, the GUIs may include more or less components, the layout or presentation of the GUIs may be different from those illustrated in FIG. 7 to FIG. 9B, and the like, without departing from the scope of the present disclosure. Further, it can be understood that the system may generate and present one or more GUIs to a second user in a similar manner, such that the second user may communicate and interact with the system to review and respond to the applications for deviation report modification and creation of the new deviation report.

To this end, example embodiments of the present disclosure provide interactive and intuitive procedures throughout the procedures of code and deviation management.

Specifically, whenever a source code violates a coding rule, the system may determine viable solutions for addressing the violation, taking into consideration the user feedback and intention. For instance, context-aware recommendations on possible modifications can be provided, the users may provide feedback throughout the processes, and the system may update the recommendation on possible solutions based on the user feedback in real-time (or near real-time). Accordingly, a solution for addressing the coding rule violation can be more accurately and efficiently determined.

Further, upon determining the solution, the system may appropriately perform the required operations without requiring user intervention. For instance, when a code modification is required, the system may automatically perform the required operations to modify the source code. As another example, the system may engage with the associated users or stakeholders regarding the deviation management, without requiring the involvement of the users. Accordingly, the user burden can be reduced, and the process of solving the code violation can be simplified.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, performed by at least one processor of a system upon executing instructions for implementing a large language model (LLM), comprising:
receiving a source code;
determining whether or not the source code violates at least one coding rule;
based on determining that the source code violates the at least one coding rule, presenting information associated with the violation of the at least one coding rule to a first user;
receiving, from the first user, a first user feedback associated with the presented information;
determining, based on the first user feedback, whether or not at least one rule deviation is to be implemented;
based on determining that the at least one rule deviation is to be implemented, performing at least one operation to manage at least one deviation report according to the first user feedback; and
based on determining that the at least one rule deviation is not to be implemented, performing at least one operation to manage the source code.

2. The method according to claim 1, wherein the presenting the information comprises:
determining whether or not at least one code modification for modifying the source code to avoid the violation of the at least one coding rule is available; and
based on determining that the at least one code modification is available, presenting information of the at least one code modification to the first user.

3. The method according to claim 2, wherein the presenting the information:
based on determining that the at least one code modification is not available, determining whether or not at least one deviation report modification is available, wherein the deviation report modification comprises modification on an existing deviation report to avoid violation of the at least one coding rule;
based on determining that the at least one deviation report modification is available, presenting information associated with the at least one deviation report modification to the first user; and
based on determining that the at least one deviation report modification is not available, presenting a notification to notify the first user to create a new deviation report.

4. The method according to claim 2, wherein the determining whether or not the at least one rule deviation is to be implemented comprises:
determining whether the first user feedback comprises an approval or a rejection on the at least one code modification;
based on determining that the first user feedback comprises the approval, determining that the at least one rule deviation is not to be implemented; and
based on determining that the first user feedback comprises the rejection, determining that the at least one rule deviation is to be implemented.

5. The method according to claim 3, wherein the determining whether or not at least one rule deviation is to be implemented comprises:
determining whether the first user feedback comprises an approval or a rejection on the at least one deviation report modification; and
based on determining that the first user feedback comprises the approval, determining that the at least one rule deviation is to be implemented.

6. The method according to claim 3, wherein the determining whether or not at least one rule deviation is to be implemented comprises:
determining whether the first user feedback comprises an approval or a rejection on the creation of the new deviation report;
based on determining that the first user feedback comprises the approval, determining that the at least one rule deviation is to be implemented; and
based on determining that the first user feedback comprises the rejection, determining that the at least one rule deviation is not to be implemented.

7. The method according to claim 2, wherein the performing the at least one operation to manage the source code comprises modifying the source code based on the at least one code modification.

8. The method according to claim 3, wherein the performing the at least one operation to manage the at least one deviation report comprises modifying the existing deviation report based on the at least one deviation report modification.

9. The method according to claim 3, wherein the performing the at least one operation to manage the at least one deviation report comprises creating the new deviation report.

10. The method according to claim 9, wherein modifying the existing deviation report comprises:
obtaining, from a database, the existing deviation report;
summarizing the first user feedback;
modifying the existing deviation report to include information of the summarized first user feedback;
providing, to a second user, the modified deviation report;
receiving, from the second user, a second user feedback on the modified deviation record; and
storing, to the database, the modified deviation report and the second user feedback.

11. The method according to claim 9, wherein the creating the new deviation report comprises:
summarizing the first user feedback;
creating the new deviation report based on the summarized first user feedback;
providing, to a second user, the new deviation report;
receiving, from the second user, a second user feedback on the new deviation record; and
storing, to a database, the new deviation report and the second user feedback.

12. The method according to claim 1, wherein the presenting the information associated with the violation comprises:
generating at least one graphical user interface (GUI) including at least one chat window and at least one interactive element, wherein the at least one chat window comprises the information associated with the violation and the at least one interactive element allows the first user to interact with the at least one chat window to provide the first user feedback; and
presenting, to the first user, the at least one GUI.

13. The method according to claim 12, further comprising:
receiving the first user feedback via the at least one GUI;
updating the at least one GUI based on the first user feedback; and
presenting, to the first user, the at least one updated GUI.

14. A system for code and deviation management, the system comprising:
a memory storage storing computer-executable instructions for implementing a large language model (LLM); and
at least one processor communicatively coupled to the memory storage, wherein the at least one processor is configured to execute the instructions to:
receive a source code;
determine whether or not the source code violates at least one coding rule;
based on determining that the source code violates the at least one coding rule, present information associated with the violation of the at least one coding rule to a first user;
receive, from the first user, a first user feedback associated with the presented information;
determine, based on the first user feedback, whether or not at least one rule deviation is to be implemented;
based on determining that the at least one rule deviation is to be implemented, perform at least one operation to manage at least one deviation report according to the first user feedback; and
based on determining that the at least one rule deviation is not to be implemented, perform at least one operation to manage the source code.

15. The system according to claim 14, wherein the at least one processor is configured to present the information by:
determining whether or not at least one code modification for modifying the source code to avoid the violation of the at least one coding rule is available; and
based on determining that the at least one code modification is available, presenting information of the at least one code modification to the first user.

16. The system according to claim 15, wherein the at least one processor is further configured to present the information by:
based on determining that the at least one code modification is not available, determining whether or not at least one deviation report modification is available, wherein the deviation report modification comprises modification on an existing deviation report to avoid violation of the at least one coding rule;
based on determining that the at least one deviation report modification is available, presenting information associated with the at least one deviation report modification to the first user; and
based on determining that the at least one deviation report modification is not available, presenting a notification to notify the first user to create a new deviation report.

17. The system according to claim 15, wherein the at least one processor is configured to determine whether or not at least one rule deviation is to be implemented by:
determining whether the first user feedback comprises an approval or a rejection on the at least one code modification;
based on determining that the first user feedback comprises the approval, determining that the at least one rule deviation is not to be implemented; and
based on determining that the first user feedback comprises the rejection, determining that the at least one rule deviation is to be implemented.

18. The system according to claim 16, wherein the at least one processor is configured to determine whether or not at least one rule deviation is to be implemented by:
determining whether the first user feedback comprises an approval or a rejection on the at least one deviation report modification; and
based on determining that the first user feedback comprises the approval, determining that the at least one rule deviation is to be implemented.

19. The system according to claim 16, wherein the determining whether or not at least one rule deviation is to be implemented comprises:
determining whether the first user feedback comprises an approval or a rejection on the creation of the new deviation report;
based on determining that the first user feedback comprises the approval, determining that the at least one rule deviation is to be implemented; and
based on determining that the first user feedback comprises the rejection, determining that the at least one rule deviation is not to be implemented.

20. The system according to claim 15, wherein the at least one processor is configured to perform the at least one operation to manage the source code by modifying the source code based on the at least one code modification.
